(19) United States
(12) Patent Application Publication
(10) Pub. No.: US 2010/0161437 A1
(43) Pub. Date: Jun. 24, 2010

(54) SYSTEM AND METHOD FOR FACILITATING MULTI-PARTY SALE TRANSACTIONS USING RADIO-FREQUENCY IDENTIFICATIONS (RFID) AND/OR BARCODES

(75) Inventor: Siddharth PANDEY, Irving, TX (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/337,902

(22) Filed: Dec. 18, 2008

(51) Int. Cl. G06Q 30/00; G06K 7/10

(52) U.S. Cl. 705/26; 235/462.13

(57) ABSTRACT

Embodiments of the present disclosure are directed to a system and method for detecting, via a wireless device, identification information associated with at least one of products and services, wherein the at least one products and services are identified based at least in part on the identification information. The system may also provide information associated with one or more of the identified products and services to a server and receive, from the server, solicited retail information associated with the one or more identified products and services offered by one or more retailers. In addition, the system may further display, via at least one of the wireless device, a set-top box and a display device, the solicited retail information associated with the one or more identified at least one of products and services offered by the one or more retailers to a user.

### BACKGROUND INFORMATION

Consumers are frequently looking to find desired products and/or services from various retailers for the cheapest price. In many instances, consumers may travel to various marketplaces and/or showrooms of the various retailers to examine the desired products and/or services. The consumers may also travel to various marketplaces and/or showrooms of the various retailers to compare prices associated with the desired products and/or services. Moreover, the consumers may need to track a variety of models and/or types of the desired products and/or services offered by the various retailers in order to compare the price. Oftentimes, various retailers may offer a variety of models and/or types of the desired products and/or services. As a result, consumers may spend vast amount of time and money in traveling to the marketplaces and showrooms of the various retailers. Also, consumers may utilize a computer to access webpages and/or websites associated with the retailers to examine the desired products and/or services. However, the consumers may be limited in examining and/or purchasing the desired products and/or services using computers. Because of advances in recent television technology, televisions may provide consumers with additional access to multimedia technology functionality in order to facilitate consumer transactions.

### BRIEF DESCRIPTION OF THE DRAWINGS

In order to facilitate a fuller understanding of the exemplary embodiments, reference is now made to the appended drawings. These drawings should not be construed as limiting, but are intended to be exemplary only.

FIG. 1 illustrates a block diagram of a system for multi-party sale transactions using radio-frequency identification (RFID) and/or barcodes in accordance with exemplary embodiments;

FIG. 2 illustrates a block diagram of various modules of a detection system facilitating multi-party sale transactions using radio-frequency identification (RFID) and/or barcodes for providing an interactive programming guide having date toolbar and/or time toolbar, in accordance with exemplary embodiments; and

FIG. 3 illustrates a flowchart for a wireless device to facilitate multi-party sale transactions using radio-frequency identification (RFID) and/or barcodes, in accordance with exemplary embodiments.

FIG. 4 illustrates a flowchart for a service provider to facilitate multi-party sale transactions using radio-frequency identification (RFID) and/or barcodes, in accordance with exemplary embodiments.

These and other embodiments and advantages will become apparent from the following detailed description, taken in conjunction with the accompanying drawings, illustrating by way of example the principles of the various exemplary embodiments.

### DETAILED DESCRIPTION OF EMBODIMENTS

A system and method may include various exemplary embodiments for facilitating sale transactions using radio-frequency identifications (RFID) and/or barcodes. A user may utilize a wireless device having a radio-frequency identification (RFID) detector and/or a barcode scanner to detect/scan identification information associated with desired products and/or services. The wireless device may provide the identification information associated with the desired products and/or services to a service provider. Also, the wireless device may provide the identification information associated with the desired products and/or services to a set-top box and/or a display device. The service provider may provide an account for the user and/or store user information. For example, the user may provide user information to the service provider via the wireless device, set-top box, display device, and/or one or more webpages/websites associated with the service provider. The wireless device, the set-top box, the display device, and/or the service provider may determine desired products and/or services based at least in part on the identification information associated with the desired products and/or services. The service provider may provide desired products and/or services to various retailers to solicit prices associated with the desired products and/or services. The various retailers may provide the prices associated with the desired products and/or services to the service provider to be displayed to the user. The user may decide whether to purchase and/or inquire about the desired products and/or services and/or which retailer to purchase and/or inquire about the desired products and/or services. Subsequently, the service provider may provide the user information to the selected retailer.

The description below describes servers, set-top box, display devices, wireless device, radio-frequency identification (RFID) readers, radio-frequency identification (RID) tags, barcode scanners, and network elements that may include one or more modules, some of which are explicitly shown, others are not. As used herein, the term “module” may be understood to refer to computing software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. The functions described as being performed at various components may be performed at other components, and the various components may be combined and/or separated. Other modifications also may be made.

The description below also describes physical and logical elements of a system architecture, some of which are explicitly shown in figures, others that are not. The inclusion of some physical elements of a system architecture may help illustrate how a given system may be modeled. It should be noted, however, that all illustrations are purely exemplary and that the system architecture described herein may be performed on different varieties of systems which may include different physical and logical elements.

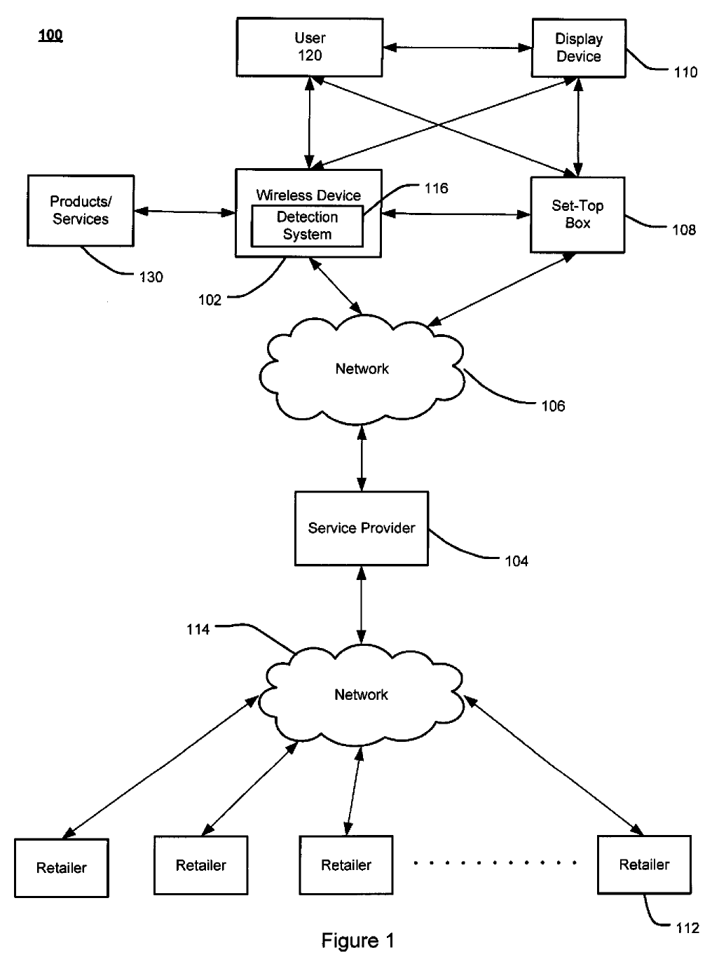

FIG. 1 illustrates a block diagram of a system for facilitating multi-party sale transactions using radio-frequency identifications (RFID) and/or barcodes in accordance with exemplary embodiments. In an exemplary embodiment, the system 100 may include a wireless device 102 coupled to a service provider 104 via a first network 106. A set-top box 108 may be coupled to a display device 110 and/or the service provider 104 via the first network 106. Also, the wireless device 102 may communicate with the set-top box 108 and/or the display device 110 via a local area network (LAN) (not shown). The service provider 104 may be coupled to one or more retailers 112 via a second network 114. In addition, the wireless device 102 may include a detection system 116 to detect identification information associated with one or more products and/or services 130. In an exemplary embodiment, a user 120 may utilize the wireless device 102 to detect and/or scan identification information associated with the products and/or services 130. The wireless device 102 may provide the identification information associated with the products and/or services 130 to the service provider 104 via the first network 106. Also, the wireless device 102 may provide the identification information associated with the products and/or services 130 to the set-top box 108 and/or the display device 110. Thereafter, the products and/or services 130 may be identified by the wireless device 102, the service provider 104, the set-up box 108, and/or the display device 11 based at least in part on the identification information associated with the products and/or services 130. The service provider 104 may provide the identified products and/or services 130 to the one or more retailers 112 via the second network 114. The one or more retailers 112 may determine retail information (e.g., price, make, specification, warranty, and shipping) associated with the products and/or services 130. Each of the one or more retailers 112 may provide the retail information associated with the products and/or services 130 to the service provider 104. The service provider 104 may process the retail information associated with the products and/or services 130 and display the retailer information to the user 120. For example, the service provider 104 may display the retail information associated with the products and/or services 130 to the user 120 via the wireless device 102, the set-top box 108, and/or the display device 110. The user 120 may select one or more retailers 112 to purchase and/or inquire about one or more products and/or services 130 and the service provider 104 may provide the user information to the one or more selected retailers 112.

Wireless device 102 may include, but is not limited to, a wireless phone, a digital telephone, a cordless telephone, a mobile phone, a satellite phone, an IP telephone and/or any other wireless communication device. According to an exemplary embodiment, wireless device 102 may include, but is not limited to, a computer device, or communications device including, for example, a personal computer (PC), a workstation, a mobile device, a handheld PC, a personal digital assistant (PDA), an alert device, a transceiver, a thin system, a fat system, a network appliance, and/or other similar computing devices capable of communication with the service provider 104, the set-top box 108, and/or the display device 110.

Detection system 116 may be coupled to or associated with the wireless device 102. For example, detection system 116 may be an external device that may be coupled to and/or wirelessly communicative with the wireless device 102. The detection system 116 may be an external device coupled to the wireless device 102 via an interface port which may include, without limitation, USB ports, system bus ports, Firewire ports, cable ports, and/or other interface ports to couple the detection system 116 to the wireless device 102. In another exemplary embodiment, the detection system 116 may be an external device that wirelessly communicates with the wireless device 102. For example, the detection system 116 may wirelessly communicate with the wireless device 102 via a local area network (LAN). The local area network (LAN) may include, but is not limited to, infrared, Bluetooth™, radio frequency (RF), and/or other methods of wireless communication. In other exemplary embodiments, detection system 116 may be integrated with the wireless device 102. Further, computer code may be stored in a storage medium associated with the wireless device 102 to control and/or operate the detection system 116.

The detection system 116 may include one or more detectors, sensors, and/or scanners to detect and/or scan identification information associated with the products and/or services 130. In an exemplary embodiment, the one or more detectors and/or sensors of the detection system 116 may be one or more radio-frequency identification (RFID) detectors and/or sensors. The products and/or services 130 may include one or more radio-frequency identification tags and/or transponders. For example, the radio-frequency identification tags may be one or more passive radio-frequency identification (RFID) tags, one or more active radio-frequency identification (RFID) tags, one or more semi-passive radio-frequency identification (RFID) tags, and/or other types of radio-frequency identification (RFID) tags. Identification information associated with the products and/or services 130 may be stored in the radio-frequency identification (RFID) tags and/or transponders. The detection system 116 may detect and/or sense the identification information transmitted by the radio-frequency identification (RFID) tags and/or transponders. In another exemplary embodiment, the detection system 116 may include a barcode scanner. The products and/or services 130 may include a barcode to represent the identification information associated with the products and/or services 130. The detection system 116 may scan the barcode associated with the products and/or services 130 in order to obtain the identification information associated with the products and/or services 130. The detection system 116 also may include, but not limited to, one or more detection devices to identify identification information associated with the one or more products and/or services 130.

The service provider 104 may include one or more entities for providing shopping services, television services, telephone services, and/or Internet services. For example, the service provider 104 may carry television/telephony/Internet signals (e.g., digital, audio, and video) over the first network 106 and the second network 114. For example, the service provider 104 may provide shopping services to the user 120 via the television/telephony/Internet signals. For example, the service provider 104 may include one or more processors/servers to provide services to the wireless device 102, the set-top box 108, and/or the display device 110 via the first network 106. Further, the service provider 104 may include one or more databases to store user information, wireless device information, product/services information, set-top box information, display information, and/or retailers' information. In an exemplary embodiment, the service provider 104 may provide one or more websites and/or webpages for the user 120 to input and/or modify user information, product/services information, and/or retailers' information.

The first network 106 and/or the second network 114 may be a wireless network, a wired network or any combination of wireless, wired and/or other network that may couple the wireless device 102, the service provider 104, and/or the set-top box 108. The first network 106 and/or the second network 114 may be disparate networks or the same network. For example, the first network 106 and/or the second network 114 may include, without limitation, wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or other wireless network. In addition, the first network 106 and/or the second network 114 may include, without limitation, telephone line, fiber optics, IEEE Ethernet 802.3, long-range wireless radio, wide area network (WAN) such as WiMax, infrared, Bluetooth™, and/or other similar applications, local area network (LAN), global network such as the Internet. Also, the first network 106 and/or the second network 114 may enable, a wireless communication network, a cellular network, an Intranet, or the like, or any combination thereof. The first network 106 and/or the second network 114 may further include one, or any number of the exemplary types of networks mentioned above operating as a stand-alone network or in cooperation with each other.

The set-top box 108 may include a media control station (not shown) and one or more databases (not shown). For example, the media control station may include a receiver to receive one or more commands/signals from the user 120, receive one or more media signals (e.g., streaming media, television programs) from the service provider 104 via the network 106, and/or an output to provide media signals to display at the display device 110. The media control station may also include a transmitter to transmit one or more commands/signals to the wireless devices 102, the service provider 104 and/or the display device 110. Other variations and components may also be provided, such as a viewer interface, additional inputs/outputs, etc. The one or more databases may store one or more product/services signals from the wireless device 102, one or more content signals from the service providers 104, and/or one or more interactive user signals from the user 120. Furthermore, the one or more databases may be local, remote, or a combination thereof to the set-top box 108. Additionally, the one or more databases may also store relevant information for personalized subscriber services. These may include user preferences, user information, service provider information, wireless device information, products/services information, retailers' information and/or other information.

The display device 110 may include computers, desktop computers, laptop computers, televisions, telephones, digital telephones, analog telephones, cellular communication devices, facsimile devices, teletype (TTY) equipments, global positioning systems (GPS), workstations, mobile devices, handheld PCs, personal digital assistants (PDA), thin systems, fat systems, network appliances, paging devices, alert devices, interactive televisions, receivers, tuners, high definition (HD) televisions, HD receivers, and/or other devices that may allow a user to view and/or interactive with the interactive programming guide.

The retailers 112 may be entities that provide sale and/or lease of products/services 130. For example, the retailers 112 may include a market, or a location where buyers and sellers conduct business transactions. The retailers 112 may include one or more shops and/or trading stores, where buyers may purchase and/or inquire about a variety of products and/or services 130. Also, retailers 112 may be a virtual retailers, where buyer may order a variety of products and/or services by mail, telephone, and/or Internet. The retailers 112 may provide retail information associated with the products and/or services 130 to the service provider 104 via the second network 114.

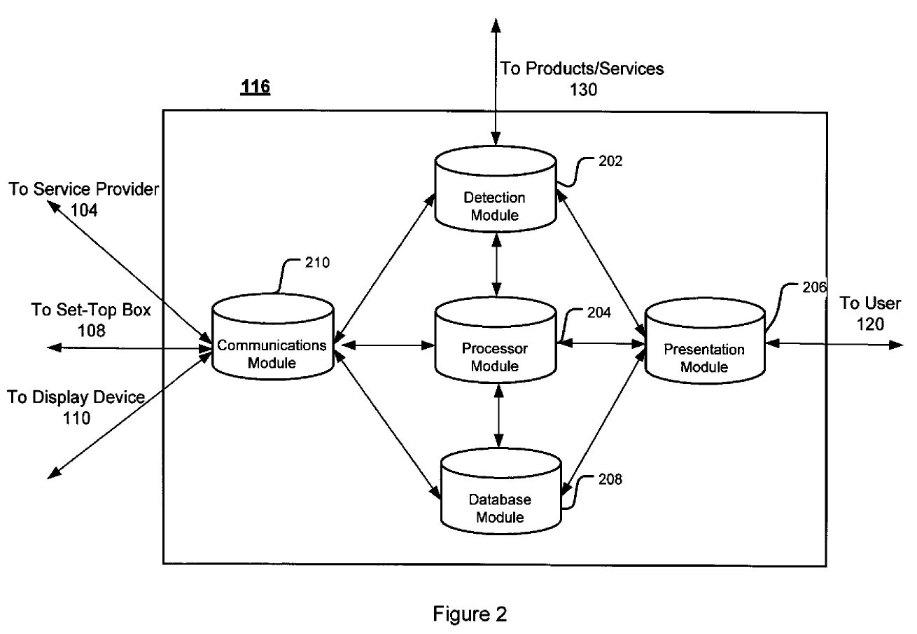

FIG. 2 illustrates a block diagram of various modules of a detection system to facilitate multi-party sales transaction using radio-frequency identifications (RFID) and/or barcodes, in accordance with exemplary embodiments. In an exemplary embodiment, the detection system 116 may facilitate multi-party sale transactions using radio-frequency identifications (RFID) and/or barcodes. The detection system 116 may include a detection module 202, a processor module 204, a presentation module 206, a database module 208, and/or a communication module 210. It is noted that the modules 202, 204, 206, 208, 210 are exemplary and the functions performed by one or more of the modules may be combined with that performed by other modules. The functions described herein as being performed by the modules 202, 204, 206, 208, and 210 also may be separated and may be performed by other modules at devices local or remote to the wireless device 102, the service provider 104, the set-top box 108 and/or the display device 110.

The detection system 116 may determine identification information associated with one or more products/services 130 via the detection module 202. For example, the detection module 202 may include one or more detectors, sensors, and/or scanners to determine identification information associated with the one or more products and/or services 130. In an exemplary embodiment, the detection module 202 may be a radio-frequency identifications (RFID) detector to detect identification information transmitted by radio-frequency identification (RFID) tags and/or transponders associated with the products and/or services 130. For example, the radio-frequency identification (RFID) tags and/or transponders may be associated or integrated with the products and/or services 130. Also, the radio-frequency identification (RFID) tags and/or transponders may be integrated with the products and/or services 130. In another exemplary embodiment, the radio-frequency identification (RFID) tags and/or transponders may be an external device located approximate to, near by, and/or adjacent to the products and/or services 130. The radio-frequency identification (RFID) tags and/or transponders associated with the products and/or services 130 may include an integrated circuit for storing and processing information, modulating and/or demodulating a radio-frequency (RF) and/or an antenna for transmitting to and/or receiving from signals from the detection module 202. The radio-frequency identification (RFID) tags and/or transponders associated with the products and/or services 130 may transmit signals to determine the identification information associated with the products and/or services 130. The signals transmitted by the radio-frequency identification (RFID) tags and/or transponders may include products and/or services identification information. The products and/or services identification information may include, but not limited to, stock keeping unit (SKU) code, universal product code (UPC), identification code, identification frequency, product and/or services name, types, price, model, specification, make, warranty, shipping, location, retailer name, time, and/or other identification information associated with the products and/or services 130. The detection module 202 may detect and/or sense the identification information associated with the product and/or services 130 transmitted by the radio-frequency identification (RFID) tags and/or transponders.

In an exemplary embodiment, the detection module 202 may be a barcode reader, detector, and/or other barcode readable machine. For example, one or more barcodes may be associated or integrated with the products and/or services 130. The barcodes may represent identification information associated with the products and/or services 130. In an exemplary embodiment, the barcodes may be integrated with the products and/or services 130. Also, the barcodes may be an external device located approximate to, near by or adjacent to the products and/or services 130. For example, the barcodes may be a matrix code, 2-dimension code, linear code, and/or other codes that represent identification information associated with the products and/or services 130. The products and/or services identification information may include, but not limited to, stock keeping unit (SKU) code, universal product code (UPC), identification code, identification frequency, products and/or services name, types, models, prices, location, retailer name, time, and/or other identification information associated with the products and/or services 130. The detection module 202 may scan and/or detect the product and/or services identification information represented by the barcodes.

The detection module 202 may preprocess the identification information associated with the product and/or services 130, e.g., demodulate, decode, filter, format, aggregate, etc. The preprocessing of the products and/or services identification information may include demodulating the products and/or services identification information, decoding the products and/or services identification information and/or formatting products and/or services identification information into useful format, and/or products and/or services identification information aggregation where identification information may be gathered and expressed in a summary form. The product and/or services identification information may be transferred from the detection module 202 to the processor module 204, the presentation module 206, the database module 208, and/or the communication module 210.

The processor module 204 may retrieve the product and/or services identification information from the detection module 202 and/or the detection module 202 may provide the product and/or services identification information to the processor module 204. The processor module 204 may further include a plurality of sub-processor modules to perform various types of data processing. Also, the processor module 204 may further include a plurality of database modules (e.g., read-only memory (ROM), random-access memory (RAM)) to store predetermined products and/or services identification information. In an exemplary embodiment, the processor module 204 may determine the products and/or services 130 based at least in part on the products and/or services identification information determined by the detection module 202. For example, the processor module 204 match the products and/or services identification information from the detection module 202 with the predetermined products and/or services identification information stored in the processor module 204 and/or the database module 208. Also, the processor module 204 may perform a look-up function. For example, the predetermined products and/or services identification information may be stored and/or arranged in a table/chart format, tree data structure, hierarchal format, and/or other formats/structures. The processor module 204 may look-up predetermined products and/or service identification information stored in the processor module 204 and/or database module 208 based on the products and/or services identification information from the detection module 202 in order to determine the products and/or services 130. Also, the processor module 204 may summarize and/or aggregate the products and/or services identification information from the detection module 202 to provide a complete report of the products and/or services 130 identified by the user 130.

The processor module 204 may provide the identified products and/or services 130 to the presentation module 206. The presentation module 206 may provide an interface between the user 120 and the detection system 116. The presentation module 206 may include a user interface, e.g., a graphical user interface, to receive requests from the user 120 and/or to provide information associated with the user 120 via the wireless device 102. The presentation module 206 may provide the data and/or analysis results to one or more user devices 102 for display. As a result, the detection system 116 may allow the user 120 to monitor and/or verify the identified products and/or services 130. In an exemplary embodiment, the processor module 204 may provide the identified products and/or services 130 to the presentation module 206 and the presentation module 206 may display the products and/or services 130 to the user 120 via the wireless device 102. Also, the presentation module 206 may display the products and/or services 130 to the user via the set-top box 108 and/or the display device 110. The user 120 may verify whether the products and/or services 130 displayed are desired by the user 120. For example, the user 120 may confirm that the displayed products and/or services 130 are desired by the user 120. Also, the user 120 may refute that the displayed products and/or services 130 are desired by the user 120. In the event that the displayed products and/or services 130 are not desired by the user 120, the user 120 may modify and/or change the display produced and/or services 130.

The presentation module 206 may include an Application Programming Interface (API) to interact with the wireless device 102. For example, the user 120 may use the wireless device 102 to input one or more requests from the user 120. In response to receiving the one or more requests from the user 120 via the wireless device 102, the presentation module 206 may send requests (or control signals, etc.) to the detection module 202, the processor module 204, the database module 208, and/or the communication module 210. In response to the request, (a) the processor module 204 may receive input from the user 120 and determine the products and/or services 130 desired by the user 120, (b) the detection module 202 may detect signals transmitted by the radio-frequency identifications (RFID) tags and/or transponders and/or scan the barcodes associated with the products and/or services 130, and/or (c) provide identified products and/or services 130 to the presentation module 206.

The database module 208 may store and/or manage data. The database module 208 may provide an interface, e.g., a uniform interface, for other modules within the detection system 116 and may write, read, and search data in one or more repositories or databases. The database module 208 may also perform other functions, such as, but not limited to, concurrent access, backup and/or archive functions. Also, due to limited amount of storage the database module 208 may compress, store, transfer and/or discard the data stored within after a period of time, e.g., a month. Also, the database module 208 may store user information, products and/or services identification information in one or more repositories and/or databases. For example, the user information stored in the database module 208 may include, but not limited to, user name, user address, user billing information, credit card number, bank account number, bank routing number, user password, user interests, and/or other information associated with the user 120 for secure purchasing of the one or more products and/or services 130. The database module 208 may store predetermined products and/or services identification information. For example, the predetermined products and/or services identification information may be associated with one or more products and/or services 130. The database module 208 may provide the predetermined products and/or services identification information to the detection module 202 and/or the processor module 204 in order to determine the products and/or services 130. The database module 208 may receive requests and/or updates from the user 120 and/or the service provider 104 to update the user information and/or the predetermined products and/or services identification information. For example, the requests and/or updated from the user 120 and/or the service provider 104 may modify and/or update the user information and/or the products and/or services identification information.

The detection system 116 may communicate with the service provider 104, the set-top box 108, and/or the display device 110 via the communication module 210. For example, the communication module 210 may receive one or more signals from the detection module 202, processor module 204, the database module 208, and/or the service provider 104. In an exemplary embodiment, the detection module 202 may transmit the products and/or services identification information and/or the identified products and/or services 130 to the communication module 210. Also, the processor module 204 may transmit the identified products and/or services 130 and/or the products and/or services identification information to the communication module 210. Moreover, the database module 208 may transmit the products and/or services 130 and/or the products and/or services identification information to the communication module 210. The communication module 210 may transmit the products and/or services 130 and/or the products and/or services identification information to the service provider 104 via the first network 106. In an exemplary embodiment, the communication module 210 may transmit the products and/or services 130 and/or the products and/or services identification information continuously, periodically, and/or intermittently. In an exemplary embodiment, the communication module 210 may transmit the products and/or services 130 and/or products and/or services identification information to the service provider 104 every millisecond, second, minute, hour, day, or weeks, etc. In another exemplary embodiment, the communication module 210 may transmit upon the reception of the products and/or services 130 and/or the products and/or service identification information automatically, iteratively or upon a request by the user 120 and/or the service provider 104. For example, the communication module 210 may transmit the products and/or services 130 and/or the products and/or services identification information when the detection system 116 and/or the wireless device 102 are turned on. Also, the communication module 210 may transmit the products and/or services 130 and/or the products and/or services identification information upon the reception of request signals from the presentation module 206.

The service provider 104 may communicate with the detection system 116 via the communication module 210. The service provider 104 may receive the products and/or services 130 and/or products and/or services identification information from the communication module 210. Also, the service provider 104 may obtain the products and/or services 130 and/or products and/or services identification information from the communication module 210. The service provider 104 may determine the products and/or services 130 based on the products and/or services identification information transmitted by the communication module 210. The service provider 104 may determine the products and/or services 130 based on a process similar to the process performed by processor module 204, as described above. Also, the service provider 104 may include one or more databases to store the predetermined products and/or services identification information, products and/or services 130 and/or the products and/or services identification information from the detection system 116.

The service provider 104 may communicate with one or more retailers 112 via the second network 114. In an exemplary embodiment, the service provider 104 may provide the products and/or services 130 to the one or more retailers 112 in order to solicit retail information (e.g., prices, specification, model, images, and/or shipping) associated with the products and/or services 130. In an exemplary embodiment, the service provider 104 may have a relationship with the one or more retailers 112 in order to obtain a discounted prices for the products and/or services 130 offered by the one or more retailers 112. The retailers 112 upon reception of the products and/or services 130 from the service provider 104 may respond with the retail information associated with the received products and/or services 130. The retailers 112 may transmit the retail information (e.g., prices, specification, model, images, and/or shipping) associated with the products and/or services 130 to the service provider 104 via the second network 114. The service provider 104 may present the retail information associated with the products and/or services 130 to the user 130 via the wireless device 102, the set-top box 108, and/or the display device 110. The user 120 may decide whether to purchase and/or inquire about the products and/or services 130 based at least in part on the retail information associated with the products and/or services 130. For example, the user 120 may purchase and/or inquire about the products and/or services 130 from the retailer 112 that may offer the cheapest price. Thereafter, the retailer 112 may deliver the products and/or services 130 to the user 120.

In an exemplary embodiment, the processor module 204, the service provider 104, the set-top box 108, and/or the display device 110 may process the retail information associated with the products and/or services 130 before presenting the retail information associated with the products and/or services 130 to the user 120. In an exemplary embodiment, different retailers 112 may submit different retail information (e.g., price) associated with the products and/or services 13 to the service provider 104. The processor module 204, the service provider 104, the set-top box 108, and/or the display device 110 may arrange the prices associated with the products and/or services 130 offered by different retailers 112. For example, the processor module 204, the service provider 104, the set-top box 108, and/or the display device 110 may arrange the products and/or services 130 offered by different retailers 112 from lowest price to the highest price. The processor module 204, the service provider 104, the set-top box 108, and/or the display device 110 may arrange the products and/or services 130 offered by different retailers 112 from newest model to the oldest model. Also, the processor module 204, the service provider 104, the set-top box 108, and/or the display device 110 may present a predetermined number of retailers 112 having retail information associated with the products and/or services 130 offered by the predetermined number of retailers 112. For example, the processor module 204, the service provider 104, the set-top box 108, and/or the display device 110 may present five cheapest products and/or services 130 offered by different retailers 112. In addition, one or more processes performed by the processor module 204, the service provider 104, the set-top box 108, and/or the display device 110 may be performed by other components of the system 100.

Also, the user 120 may access a graphical user interface provided by the service provider 104. The graphical user interface may include one or more websites and/or webpages to allow the user 120 to input user information. For example, the user information may include, but is not limited to, user name, user address, user billing information, credit card number, bank account number, bank routing number, user password, user interests, and/or other information associated with the user 120 for secure purchasing of the one or more products and/or services 130. The detection system 116 may receive the user information from the service provider 104 via the communication module 210. Also, the user 120 may update the user information via a graphical user interface (e.g., webpages/websites, a keypad, and/or a keypad) associated with the service provider 104, the wireless device 102, the set-top box 108, and/or the display device 110. In an exemplary embodiment, the detection system 116 may receive the updated user information via the communication module 210. The communication module 210 may transfer the user information and/or the updated user information to the database module 208 and the user information and/or the updated user information may be stored at the database module 208.

Referring to communication module 210 again, the communication module 210 may transmit the products and/or services 130 and/or the products and/or services identification information to the user 120 via the set-top box 108 and/or the display device 110. In an exemplary embodiment, the communication module 210 may transmit the products and/or services 130 and/or the products and/or services identification information to the set-top box 108 and/or the display device 110 via a local area network (LAN). For example, the local area network (LAN) may include, but is not limited to, infrared, Bluetooth™, radio frequency (RF), and/or other methods of wireless communication.

In an exemplary embodiment, the communication module 210 may provide the products and/or services 130 and/or the products and/or services identification information to the set-top box 108. In the event that the communication module 210 may provide the products and/or services identification information, the set-top box 108 may determine the products and/or services 130 based on the products and/or services identification information transmitted by the communication module 210. The set-top box 108 may perform process similar to the processor module 204 and/or the service provider 104, as described above, in order to determine the products and/or services 130. The set-top box 108 may present the products and/or services 130 and/or products and/or services identification information via the display device 110. Also, the set-top box 108 may include one or more databases to store the products and/or services 130 and/or the products and/or services identification information.

In another exemplary embodiment, the display device 110 may receive the products and/or services 130 and/or the products and/or services identification information from the communication module 210 and/or the set-top box 108. In the event that the display device 110 received products and/or services identification information, the display device 110 may determine the products and/or services 130 based on the products and/or services identification information transmitted by the communication module 210 and/or the set-top box 108. The display device 110 may perform one or more processes similar to the processor module 204, as described above, in order to determine the products and/or services 130. Also, the display device 110 may include one or more databases to store the products and/or services 130 and/or the products and/or services identification information. The one or more databases associated with the display device 110 may perform one or more processes similar to the database module 208. The display device 110 may present the products and/or services 130 and/or the products and/or services identification information to the user 120.

The user 120 may verify whether the products and/or services 130 and/or the products and/or services identification information displayed are desired by the user 120. For example, the user 120 may confirm that the displayed products and/or services 130 and/or the products and/or services identification information are desired by the user 120. Also, the user 120 may refute that the displayed products and/or services 130 and/or products and/or services identification information are desired by the user 120. In the event that the displayed products and/or services 130 are not desired by the user 120, the user 120 may modify and/or change the display products and/or services 130. Also, the user 120 may verify whether the products and/or services identification information may be correct. For example, the user 120 may confirm that the products and/or services identification information is correct. Also, the user 120 may modify and/or refute the products and/or services identification information, in the event that the products and/or services identification information is wrong. The user 120 may provide the selected products and/or services 130 for purchase and/or inquire about to the service provider 104 via the wireless device 102, the set-top box 108 and/or the display device 110. The service provider 104 may provide the selected products and/or services 130 to the one or more retailers 112 to solicit retail information associated with the selected products and/or services 130.

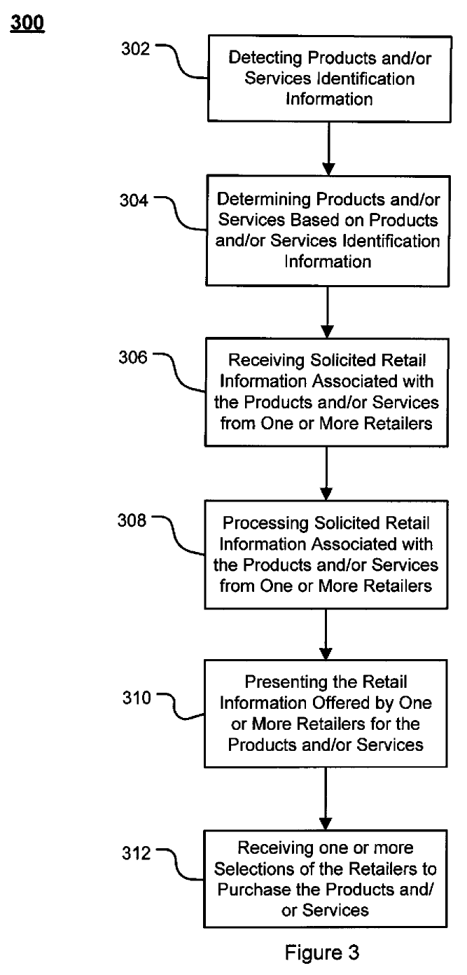

FIG. 3 illustrates a flowchart for a wireless device to facilitate multi-party sale transactions using radio-frequency identification (RFID) and/or barcodes, in accordance with exemplary embodiments. This exemplary method is provided by way of example, as there are a variety of ways to carry out methods disclosed herein. The method 300 shown in FIG. 3 can be executed or otherwise performed by one or a combination of various systems. The method 300 is described below as being carried out by the system 100 shown in FIGS. 1 and 2 by way of example, and various elements of the system 100 are referenced in explaining the example method of FIG. 3. Each block shown in FIG. 3 represents one or more processes, methods, or subroutines carried in the exemplary method 300. The method 300 may begin at block 302.

At block 302, the method 300 may detect products and/or services identification information. For example, products and/or services 130 may include radio-frequency identification tags and/or transponders and/or barcodes to transmit the products and/or services identification information. The products and/or services identification information may include, but not limited to, identification code, identification frequency, product and/or services name, types, price, model, specification, image, make, warranty, shipping models, expiration date, location, retailer name, time, and/or other identification information associated with the products and/or services 130. The radio-frequency identification tags and/or transponders associated with the products and/or services 130 may transmit signals including the products and/or services identification information. The barcodes associated with the products and/or services 130 may include codes representing the products and/or services identification information. A user 120 may utilize a detection system 116 to detect the products and/or services identification information. For example, the detection system 116 may include a detection module 202 to detect the products and/or services identification information. For example, the detection module 202 may include a radio-frequency identifications (RFID) detector and/or a barcode reader. After detecting products and/or services identification information the method 300 may proceed to block 304.

At block 304, the products and/or services 130 may be determined based at least in part on the products and/or services identification information. For example, the detection module 202 may provide the products and/or services identification information to a processor module 204 of the detection system 116. The processor module 204 may determine the products and/or services 130 based at least in part on the product and/or services identification information. The detection module 202 may provide the products and/or services identification information to a service provider 104 via a communication module 210. The service provider 104 may determine the products and/or services 130 based at least in part on the products and/or services identification information. The detection module 202 may provide the products and/or services identification information to a set-top box 108 and/or a display device 110. Also, the set-top box 108 and/or the display device 110 may determine the products and/or services 130 based at least in part on the products and/or services identification information. After determining the products and/or services based at least in part on the products and/or services identification information, the method 300 may proceed to block 306.

At block 306, solicited retail information associated with the products and/or services 130 from the one or more retailers 112 may be received. For example, the user 120 may select to purchase and/or inquire about one or more products and/or services 130. The wireless device 102, the set-top box 108, and/or the display device 110 may receive solicited retail information associated with the products and/or services 130 from the one or more retailers 112 via the service provider 104. In an exemplary embodiment, the service provider 104 may receive solicited retail information associated with the products and/or services 130 from the one or more retailers 112 via a second network 114. For example, the solicited retail information may include, but not limited to, prices, specification, model, images, warranty, shipping and/or other information associated with the products and/or services 130. Thereafter, the service provider 104 provide the solicited retail information associated with the products and/or services 130 to the wireless device 102, the set-top box 108, and/or the display device 110. After receiving solicited retail information associated with the products and/or services 130 from one or more retailers 112, the method of 300 may proceed to block 308.

At block 310, the retail information associated with the products and/or services 130 offered by the one or more retailers 112 may be processed. For example, different retailers 112 may submit different retail information (e.g., price) associated with the products and/or services 13 to the service provider 104. The processor module 204, the service provider 104, the set-top box 108, and/or the display device 110 may arrange the prices associated with the products and/or services 130 offered by different retailers 112. Also, the processor module 204, the service provider 104, the set-top box 108, and/or the display device 110 may arrange the products and/or services 130 offered by different retailers 112 from newest model to the oldest model. Also, the processor module 204, the service provider 104, the set-top box 108, and/or the display device 110 may present a predetermined number of retailers 112 having retail information associated with the products and/or services 130 offered by the predetermined number of retailers 112. After processing the retail information associated with the products and/or services 130 offered by the one or more retailers 112, the method 300 may proceed to block 310.

At block 310, the retail information associated with the products and/or services 130 offered by the one or more retailers 112 may be presented to the user 120. For example, the wireless device 102, the set-top box 108, and/or the display device 110 may provide the retail information associated with the products and/or services 130 offered by the one or more retailers 112 to the user 120. For example, the wireless device 102 may provide the retail information associated with the products and/or services 130 offered by the one or more retailers 112 to the user 120. Also, the set-top box 108 and/or the display device 110 may provide the retail information associated with the products and/or services 130 offered by the one or more retailers 112 to the user 120. After presenting the retail information offered by the one or more retailers 112 for the products and/or services 130, the method 300 may proceed to block 312.

At block 312, one or more selections of the retailers 112 to purchase and/or inquire about the products and/or services 130 from may be received. For example, the user 120 may select one or more retailers 112 to purchase and/or inquire about the products and/or services 130 via a keypad and/or a keyboard associated with the wireless device 102. The wireless device 102 may provide the one or more selected retailers 112 to the service provider 104. Also, the user 120 may select one or more retailers 112 to purchase and/or inquire about the products and/or services 130 via a keypad and/or a keyboard associated with the set-top box 108 and/or the display device 110. The set-top box 108 and/or the display device 110 may provide the selected retailer 112 to the service provider 104.

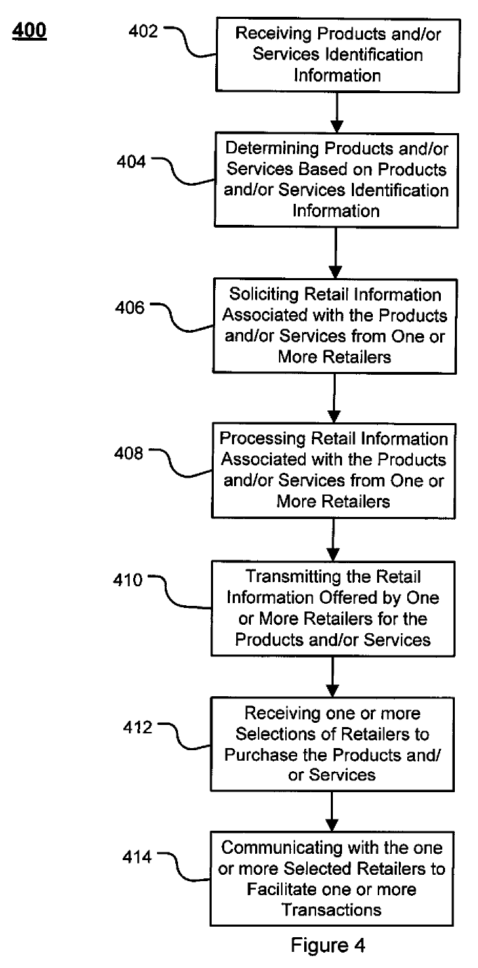

FIG. 4 illustrates a flowchart for a service provider to facilitate multi-party sale transactions using radio-frequency identification (RFID) and/or barcodes, in accordance with exemplary embodiments. This exemplary method is provided by way of example, as there are a variety of ways to carry out methods disclosed herein. The method 400 shown in FIG. 4 can be executed or otherwise performed by one or a combination of various systems. The method 400 is described below as being carried out by the system 100 shown in FIGS. 1 and 2 by way of example, and various elements of the system 100 are referenced in explaining the example method of FIG. 4. Each block shown in FIG. 4 represents one or more processes, methods, or subroutines carried in the exemplary method 400. The method 400 may begin at block 402.

At block 402, the method 400 may receive products and/or services identification information. For example, a service provider 104 may receive product and/or services 130 and/or the products and/or services identification information from a wireless device 102, a set-top box 108, and/or a display device 110. In an exemplary embodiment, a user may utilize a detection system 116 to detect the products and/or services identification information. The detection system 116 may transmit the products and/or services identification information to the service provider 104 via the wireless device 102. Also, the detection system 116 may provide the products and/or services identification information to the set-top box 108 and/or the display device 110 via the wireless device 102. The set-top box 108 and/or the display device 110 may provide the products and/or services identification information to the service provider 104 via a network 106. After receiving the products and/or services identification information the method 400 may proceed to block 404.

At block 404, the products and/or services 130 may be determined based at least in part on the products and/or services identification information. For example, the service provider 104 may determine the products and/or services 130 based at least in part on the products and/or services identification information. Also, the detection system 116 may determine the products and/or services 130 based at least in part on the products and/or services identification information and provide the products and/or services 130 to the service provider 104. In another exemplary embodiment, the set-top box 108 and/or the display device 110 may determine the products and/or services 130 based at least in part on the products and/or services identification information. Thereafter, the set-top box 108 and/or the display device 110 may provide the products and/or services 130 to the service provider 104 via the network 106. After determining the products and/or services 130 based at least in part on the products and/or services identification information, the method 400 may proceed to block 406.

At block 406, retail information associated with the products and/or services 130 may be solicited from one or more retailers 112. For example, the user 120 may select to purchase and/or inquire about one or more products and/or services 130. The service provider 104 may provide the products and/or services 130 selected by the user 120 for purchase and/or inquire about to the one or more retailers 112, in order to solicit retail information (e.g., prices, specification, model, images, warranty, and shipping) associated with the products and/or services 130. The one or more retailers 112 may provide retail information associated with the products and/or services 130 to the service provider 104. After soliciting retail information associated with the products and/or services 130 from one or more retailers 112, the method of 400 may proceed to block 408.

At block 408, the retail information associated with the products and/or services 130 offered by the one or more retailers 112 may be processed. For example, different retailers 112 may submit different retail information (e.g., price) associated with the products and/or services 13 to the service provider 104. The processor module 204, the service provider 104, the set-top box 108, and/or the display device 110 may arrange the prices associated with the products and/or services 130 offered by different retailers 112. Also, the processor module 204, the service provider 104, the set-top box 108, and/or the display device 110 may arrange the products and/or services 130 offered by different retailers 112 from newest model to the oldest model. Also, the processor module 204, the service provider 104, the set-top box 108, and/or the display device 110 may present a predetermined number of retailers 112 having retail information associated with the products and/or services 130 offered by the predetermined number of retailers 112. After processing the retail information associated with the products and/or services 130 offered by the one or more retailers 112, the method 400 may proceed to block 410.

At block 410, the retail information associated with the products and/or services 130 offered by the one or more retailers 112 may be transmitted to the wireless device 102, the set-top box 108, and/or the display device 110. For example, the service provider 104 may transmit the retail information associated with the products and/or services 130 offered by the one or more retailers 112 to the wireless device 102 via the network 106. Also, the service provider 104 may provide the retail information associated with the products and/or services 130 offered by the one or more retailers 112 to the set-top box 108 and/or the display device 110. After transmitting the retail information offered by the one or more retailers 112 for the products and/or services 130, the method 400 may proceed to block 412.

At block 412, one or more selections of retailers 112 to purchase and/or inquire about the products and/or services 130 may be received. For example, user 120 may select one or more retailers 112 to purchase and/or inquire about the products and/or services 130 via a keypad and/or a keyboard associated with the wireless device 102. The wireless device 102 may provide the one or more selected retailers 112 to the service provider 104. Also, the user 120 may select one or more retailers 112 to purchase and/or inquire about the products and/or services 130 via a keypad and/or a keyboard associated with the set-top box 108 and/or the display device 110. The set-top box 108 and/or the display device 110 may provide the selected one or more retailers 112 to the service provider 104. After receiving one or more selection of retailers 112 to purchase and/or inquire about the products and/or services 130, the method 400 may proceed to block 414.

At block 414, the service provider 104 may communicate with the one or more selected of retailers 112 to facilitate one or more transactions. For example, the service provider 104 may provide user information associated with the user 120 to the one or more selected retailer 112. The user information may include, but not limited to, user name, user address, user billing information, credit card number, bank account number, bank routing number, user password, user interests, and/or other information associated with the user 120 for secure purchasing of the one or more selected products and/or services 130. Also, the one or more retailers 112 may deliver the one or more selected products and/or services 130 to the user 120.

In the preceding specification, various embodiments have been described with reference to the accompanying drawings. It will, however, be evident that various modifications and changes may be made thereto, and additional embodiments may be implemented, without departing from the broader scope of the disclosure as set forth in the claims that follow. The specification and drawings are accordingly to be regarded in an illustrative rather than restrictive sense.

1. A method, comprising:
detecting, via a wireless device, identification information associated with at least one of products and services, wherein the at least one products and services are identified based at least in part on the identification information;
providing the identification information associated with one or more of the identified products and services to a server;
receiving, from the server, solicited retail information associated with the one or more identified products and services offered by a plurality of retailers; and
displaying, via a set-top box, the solicited retail information associated with the one or more identified at least one of products and services offered by the plurality of retailers to a user, wherein the wireless device is capable of detecting the identification information associated with at least one of products and services at any of the plurality of retailers.

2. The method of claim 1, wherein the identification information associated with at least one of products and services comprising at least one of identification code, identification frequency, products and services name, products and services types.

3. The method of claim 1, wherein detecting via a wireless device, identification information comprises detecting one or more radio-frequency identification (RFID) signals having the identification information.

4. The method of claim 1, wherein detecting the identification information comprises scanning one or more barcodes representing the identification information.

5. The method of claim 1, wherein the at least one products and services are identified by matching the detected identification information associated with the at least one products and services with predetermined identification information associated with the at least one products and services.

6. The method of claim 1, wherein the at least one products and services are identified by looking up predetermined identification information associated with the at least one products and services.

7. The method of claim 1, wherein the retail information comprises at least one of price, make, specification, warranty, and shipping.

8. The method of claim 1, further comprises processing the solicited retail information by arranging the solicited retail information associated with the at least one of products and services offered by the plurality of retailers based at least in part on prices associated with the at least one of products and services.

9. The method of claim 1, further comprises processing the solicited retail information by arranging the solicited retail information associated with the at least one of products and services offered by the plurality of retailers based at least in part on models associated with the at least one of products and services.

10. The method of claim 1, further comprises processing the solicited retail information by providing a predetermined number of the plurality of retailers offering the solicited retail information associated with the at least one of the products and services offered by the predetermined number of the plurality of retailers.

11. The method of claim 1, further comprises receiving, from the set-top box, one or more selections of at least one of the plurality of retailers to purchase the at least one of products and services.

12. A computer readable non-transitory storage media comprising computer executable code to perform the steps of the methods of claim 1.

13. A method, comprising:
receiving, at a server, detected identification information associated with at least one of products and services, wherein the at least one of products and services are identified based at least in part on the identification information;
soliciting, from one or more retailers, retail information associated with one or more of the identified products and services based at least in part on the detected identification information received at the server; and
transmitting, via a set-top box, the retail information associated with the one or more of the identified products and services from the one or more retailers to a user.

14. The method of claim 13, further comprises receiving, from the set-top box, one or more selections of at least one of the one or more retailers to purchase the one or more of the identified products and services.

15. The method of claim 13, further comprises communicating with the one or more retailers to facilitate a transaction of the one or more of the identified products and services.

16. The method of claim 15, wherein communicating with the one or more retailers to facilitate the transaction of the one or more of the identified products and services comprises transmitting user information from the server to the one or more retailers.

17. The method of claim 13, further comprises processing the retail information by arranging the retail information associated with the one or more of the identified products and services from the one or more retailers based at least in part on prices associated with the one or more of the identified products and services.

18. The method of claim 13, further comprises processing the retail information by arranging the retail information associated with the one or more of the identified products and services from the one or more retailers based at least in part on models associated with the one or more of the identified products and services.

19. The method of claim 13, further comprises processing the retail information by providing a predetermined number of the one or more retailers offering the retail information associated with the one or more of the identified products and services offered by the predetermined number of the one or more retailers.

20. A system, comprising:
a detection module configured to detect identification information associated with at least one of products and services, wherein the detection module is capable of detecting the identification information associated with at least one of products and services at any of a plurality of retailers;
a processor module configured to identify one or more of the at least one of products and services based at least in part on the identification information;
a communication module configured to solicit retail information associated with the one or more identified products and services from the plurality of retailers based at least in part on the detected identification information; and
a presentation module configured to display the retail information associated with the one or more identified products and services from the plurality of retailers to a user via a set-top box.

21. The system of claim 20, wherein the detection module includes at least one of radio-frequency identification (RFID) detectors and barcode scanners.

22. The system of claim 20, further comprise at least one of a radio-frequency identification (RFID) tag, a radio-frequency identification (RFID) transponder, a barcode associated with the at least one of products and services.

23. The system of claim 20, further comprises a database module configured to store at least one of user information, the detected identification information associated with the at least one of products and services, and predetermined identification information associated with the at least one of products and services.

24. The system of claim 20, wherein the communication module is configured to provide the identification information associated with the at least one of products and services to at least one of a set-top box and a display device.

25. The system of claim 20, wherein the communication module is configured to provide the identification information associated with the at least one of products and services to a server associated with a service provider.

26. The system of claim 20, wherein the presentation module includes a graphical user interface.

27. The system of claim 20, wherein the presentation module is configured to display identification information associated with at least one of products and services to the user.
